(19) United States
(12) Patent Application Publication
(10) Pub. No.: US 2016/0300028 A1
(43) Pub. Date: Oct. 13, 2016

(54) TRANSFERRING DEVICE SETTINGS

(71) Applicant: DRAEGER MEDICAL SYSTEMS, INC., Andover, MA (US)

(72) Inventors: Joshua ABELL, Beverly, MA (US); Michael D. HIRST, Hudson, MA (US)

(21) Appl. No.: 14/896,654

(22) PCT Filed: Nov. 20, 2014
(86) PCT No.: PCT/US14/66639

§ 371 Date: Dec. 7, 2015

(51) Int. Cl. G06F 19/00; H04L 29/08; G06F 9/445

(52) U.S. Cl. CPC G06F 19/3412; G06F 9/44505; H04L 67/26

(57) ABSTRACT

An optical sensor in operation with at least one data processor forming part of at least one computing system receives data including an instruction to obtain settings from a source medical device. The optical sensor scans a field of view of the optical sensor to acquire a first identifier associated with the source medical device. Data comprising instructions to retrieve settings for the source medical device associated with the first identifier is transmitted. Transfer of instructions to a destination medical device is initiated, which when received by the destination medical device, causes the destination medical device to update using the settings. Related apparatus, systems, techniques, and articles are also described.

### TECHNICAL FIELD

The subject matter described herein relates to transferring data between devices such as transferring settings and historical patient data between medical devices in a healthcare setting.

### BACKGROUND

Settings or operating parameters configure a point of care medical device, such as a patient monitor or ventilator, to define and control operation of the device. These settings may be based on a patient's medical condition, age, gender, and the like. The settings can define alarm limits, therapy procedures, demographic data, trends, alarm events, and the like. A healthcare worker manually configures the medical devices for a specific patient (e.g., by inputting setting values into a user interface on the medical device).

When healthcare workers move a patient from one medical device to another, for example, when moving a patient from a ventilator in an operating room to a ventilator in a recovery room, they must configure the new medical device with the same settings as the first medical device. The healthcare workers can configure the new medical device manually (e.g., by inputting setting values through a user interface on the new medical device) or by using a removable media storing the settings, such as a universal serial bus (USB) flash drive. Both methods for configuring the new medical device can be time consuming and inefficient, and may introduce errors.

### SUMMARY

In an aspect, an optical sensor in operation with at least one data processor forming part of at least one computing system receives data including an instruction to obtain settings from a source medical device. The optical sensor scans a field of view of the optical sensor to acquire a first identifier associated with the source medical device. Data comprising instructions to retrieve settings for the source medical device associated with the first identifier is transmitted. Transfer of instructions to a destination medical device is initiated, which when received by the destination medical device, causes the destination medical device to update using the settings.

In another aspect, an optical sensor in operation with at least one data processor forming part of at least one computing system receives data including an instruction to transfer settings from a source medical device. The optical sensor scans a field of view of the optical sensor to acquire a first identifier associated with the source medical device. The optical sensor scans the field of view of the optical sensor to acquire a second identifier associated with a destination medical device. Transfer of data including an instruction to transfer settings from the source medical device to the destination medical device is initiated, which when received by the destination medical device, causes the destination medical device to update using the settings.

In yet another aspect, a data marker comprising a first identifier associated with a medical device is displayed on a display of the medical device. The medical device is configured with settings for operating with a patient. Instructions to initiate transmission of the settings for use by a destination medical device associated with a second identifier that is different from the first identifier and acquired by an optical sensor from a data marker comprising the second identifier is received. The settings are transferred, which when received by the destination medical device causes the destination medical device to configure for operation with the patient using the settings.

In yet another aspect, a data marker is displayed on a display of a medical device. The data marker includes a second identifier associated with the medical device. Data including settings previously stored on a source medical device associated with a first identifier that is different from the second identifier and acquired by an optical sensor from a data marker comprising the first identifier is received. The settings are received from the source medical device in response to an instruction to transmit the settings. The source medical device being configured with the settings for operating with a patient. The medical device is configured with the received settings for operation with the patient.

One or more of the following features can be included in any feasible combination. For example, the data can include instructions to retrieve settings for the source medical device is transmitted to a network computing system. Data including an instruction to push the settings to the destination medical device can be received. The field of view of the optical sensor can be scanned to acquire a second identifier associated with the destination medical device. Data including an instruction to push settings to the destination medical device associated with the second identifier can be transmitted to the network computing system. The settings obtained from the source medical device can be received from the network computing system. The settings obtained from the source medical device can be transmitted for pushing the settings to the destination medical device.

The settings can include one or more of: patient physiological parameter trend settings, alarm event history, patient characteristics, device alarm configuration settings, patient event data, patient trend data, device operating parameters, and laboratory results. The source medical device can include a data marker including the first identifier. The optical sensor and the at least one data processor can form a wearable device and the field of view of the optical sensor can overlap with a wearer's field of view when the wearable device is worn. The source medical device can include a patient monitor, a ventilator, an infusion pump, anesthesia device, or incubator device. The first identifier can be unique to the source medical device.

The settings can be received from the source medical device. The settings obtained from the source medical device can be transmitted to the destination medical device. The source medical device can include a first data marker comprising the first identifier and the destination medical device can include a second data marker comprising the second identifier.

The settings can be transmitted over a network to the destination medical device. The settings can be transmitted to a mobile computing platform including the optical sensor. The settings can be transmitted for temporary storage and subsequent transfer from the mobile computing platform to the destination medical device. The settings can be transmitted directly from the medical device to the destination medical device.

The settings can be received over a network from the source medical device. The settings can be received from a mobile computing platform including the optical sensor. The settings can be received after reception by the mobile computing platform of the settings from the source medical device and after temporary storage of the settings by the mobile computing platform. The settings can be received by the medical device directly from the source medical device.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages. For example, the current subject matter can remove the need to enter medical device settings manually and the need to physically transport media, such as a USB flash drive, between medical devices. Medical devices can be improved because they may not require a physical data port, such as a USB or serial port, for data transfer. Such medical device improvement can simplify the devices and allow them to be smaller, cheaper, more water resistant, and the like. Settings can be transferred “hands free,” which can simplify the transfer process, reduce user error, reduce spreading of disease, and improve healthcare worker efficiency and patient care. Moreover, the settings on the first or source medical device can be removed from the device at the beginning of the setting transfer process, allowing the first medical device to be used for another patient soon after transfer. The current subject matter can provide a visual indicator to inform a user that the settings are held.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a method of transferring settings between medical devices;

FIG. 2 is a system block diagram illustrating an example implementation of a data exchange system capable of transferring settings between medical devices;

FIG. 3 is a data flow diagram illustrating flow of data within a data exchange system;

FIG. 4 illustrates the wearable device and its field of view display at different steps of an example data transfer process;

FIG. 5 is a system block diagram illustrating three data transfer techniques;

FIG. 6 is a process flow diagram illustrating an example method for transferring settings to a destination medical device, for example, implemented by a source medical device; and

FIG. 7 is a process flow diagram illustrating a method for transferring settings from a source medical device, for example, implemented by a destination medical device.

Like reference symbols in the various drawings indicate like elements.

### DETAILED DESCRIPTION

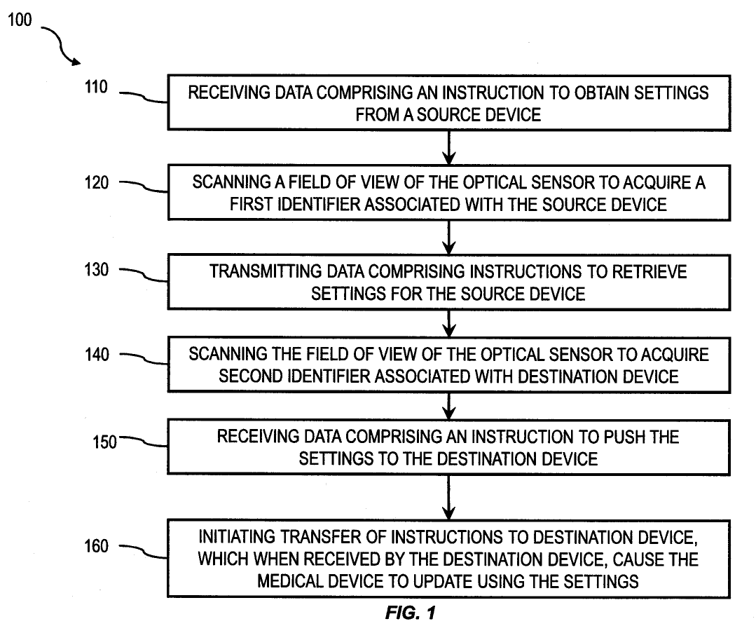

FIG. 1 is a process flow diagram illustrating a method 100 of transferring settings between medical devices. The settings can be transferred using an optical sensor, such as a camera or similar device integrated into a mobile computing system. Each medical device can have data markers, such as a barcode or other indicia, associated with each medical device and which identifies the medical device with an identifier. For example, a medical device can display a two-dimensional matrix barcode or a watermark on a user interface display, or a sticker with the barcode can be affixed to the outside of the medical device. The optical sensor can acquire the identifiers from the data markers and, using the identifiers, cause an exchange of data, which can occur during a device “hand-off.”

In some implementations, the mobile computing system is a wearable device, such as a GOOGLE GLASS® or EPSON MOVERI® in which the field of view of the optical sensor overlaps with the field of view of the wearer when the wearable device is worn so that the optical sensor “sees” what the wearer sees. In this example implementation, a wearer can initiate data exchange by “looking” at the data marker on a first medical device and then “looking” at the data marker on the second medical device.

Data can be received at 110 including an instruction to obtain settings from a source medical device. The instruction can originate or be caused to be generated by a user or wearer, for example, in the form of a verbal, tactile, gestural, or other input.

The optical sensor at 120 can scan its field of view to acquire a first identifier associated with a medical device that is to be the source of the settings. The identifier can include an alpha numeric or binary number, which can be encoded within a data marker. The identifier for a given medical device or data marker can be unique in that it uniquely identifies the associated medical device or data marker. For example, the identifier can be the uniform resource locator (URL) of the associated medical device on a network. The identifier can be a unique device identifier (UDI) issued by a United States Food and Drug Administration accredited agency. The identifier may be unique world-wide, within a hospital system, and/or within a clinical care unit. The data marker can include a sticker with a barcode, such as a matrix barcode or two-dimensional barcode, although other indicia such as plaintext are possible. In some implementations, the source medical device can display the data marker.

Additionally, the user or wearer can have pointed the field of view of the optical sensor towards the source medical device so that the data marker is within the field of view. In some implementations, the optical sensor captures an image, such as a visual, infrared image, processes the image to identify the data marker, and extracts the first identifier using image-processing techniques.

Data including instructions to retrieve settings for the source medical device can be transmitted at 130 to a network computing system. The network computing system can include a server residing on a data network, such as a hospital network, and the wearable device can transmit the instructions wirelessly. The source medical device, as well as the medical device that the settings are to be transferred to, can be connected to the data network.

The network computing system can pull the settings from the source medical device and temporarily store the settings at least until the destination medical device is identified. In some implementations, the network computing system can send the settings to the wearable device for temporary storage. If the destination medical device has already been identified, the network computing system can forward the settings to the destination medical device.

The optical sensor at 140 can scan its field of view to acquire a second identifier associated with the destination medical device. Additionally, the user or wearer can have pointed the field of view of the optical sensor towards the destination medical device so that the data marker is within the field of view. In some implementations, the optical sensor captures a visual or infrared image, processes the image to identify the data marker, and extracts the second identifier using image-processing techniques.

Data can be received at 150 including an instruction to push the settings to a destination medical device. The instruction can originate or be caused to be generated by a user or wearer, for example, in the form of a verbal, tactile, gestural, or other input.

Using the second identifier associated with the destination device, at 160, transfer of instructions can be initiated to the destination medical device. The instructions can include the settings, or the settings can be pulled by or pushed to the destination medical device. When the destination medical device receives the instructions, the instructions can cause the destination medical device to update and configure using the settings from the source medical device. Thus, the source medical device and the destination medical device can exchange the settings without manual entry of the settings.

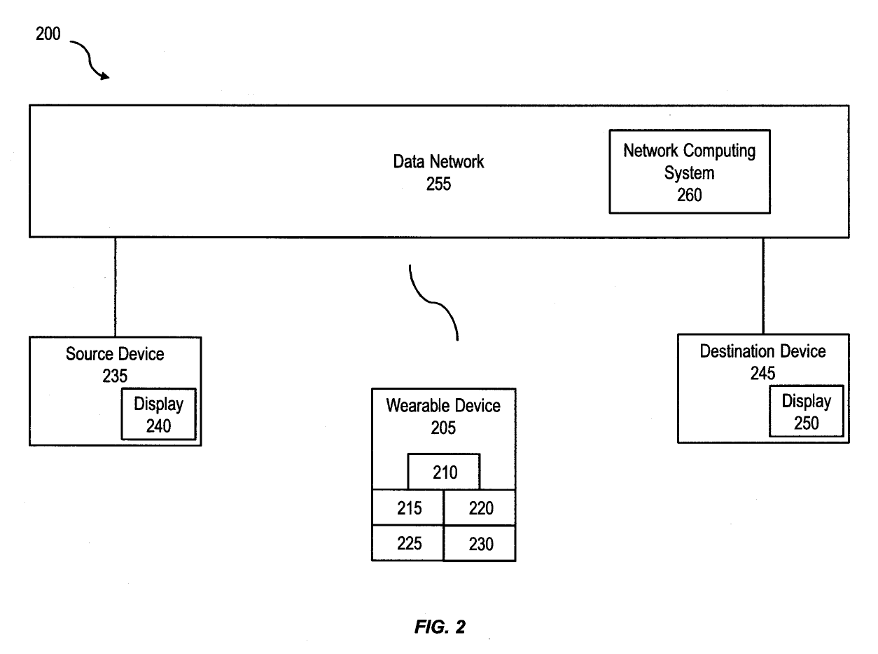

FIG. 2 is a system block diagram illustrating an example implementation of a data exchange system 200 capable of transferring settings between medical devices. A wearable device 205 includes optical sensor or camera 210, field of view display 215, microprocessor 220 including at least one data processor, wireless communications module 225, and can include voice recognition module 230. The wireless communications module 225 can include cellular, WI-FI, Bluetooth, and/or other wireless technology. The camera 210 is capable of acquiring images in both the visible and infrared spectrum in a field of view. The camera 210 field of view can overlap the field of view of the wearer of the wearable device 205 so that the camera 210 “sees” what the wearer can see. Field of view display 215 is an augmented reality display that can be semi-transparent, allowing the wearer to view the display and see through the display. The field of view display can display an indicator such as an icon that the settings are being held (e.g., by wearable device 205 or network computing system 260). Field of view display 215 may obscure a subset of the field of view of the wearer. The voice recognition module 230 allows for audio input to the wearable device 205.

Data exchange system 200 includes source device 235 having display 240. The source device 235 can include patient monitors, ventilators, infusion pumps, anesthesia devices, incubator devices, and the like. Display 240 can be configured to display a data marker having an identifier in the form of a two dimensional barcode.

Data exchange system 200 includes destination device 245 having display 250. Destination device 245 can include patient monitors, ventilators, fusion pumps, and the like. Display 250 can be configured to display a data marker having an identifier in the form of a two dimensional barcode.

Data exchange system 200 includes data network 255 connecting wearable device 205 (via wireless communications module 225), source device 235, and destination device 245. Data network 255 can include network computing system 260, such as a server or database.

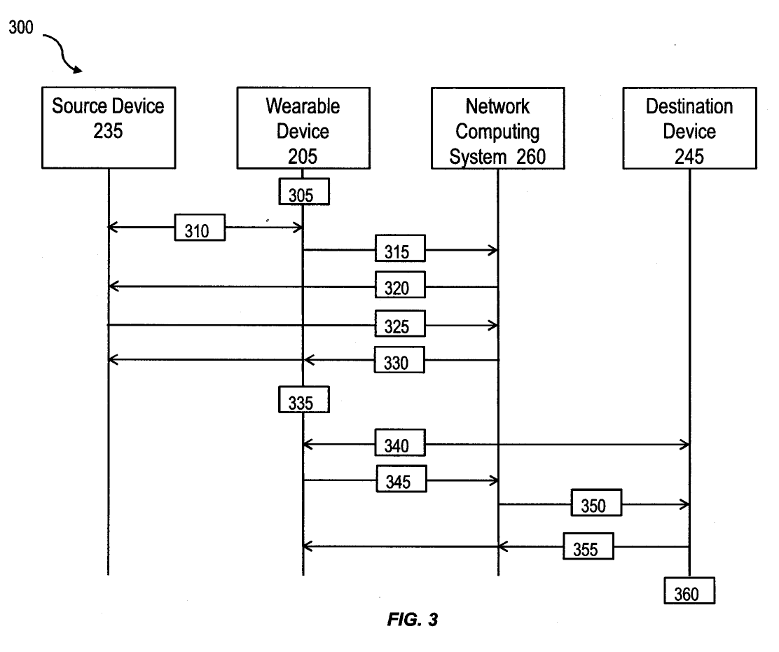

In operation, data exchange system 200 allows for transfer of settings from source device 235 to destination device 245. FIG. 3 is a data flow diagram illustrating the flow 300 of data within data exchange system 200. Wearable device 205 receives an instruction to obtain device settings at 305. The instruction can originate with a user or wearer of wearable device 205 through a user interface, such as a voice command (via voice recognition module 230), or through a gesture, or touch input. In some implementations, the instruction is automatically generated.

Wearable device 205 can scan camera's 210 field of view while source device 235 and associated data marker is within the field of view. Camera 210 can capture a visual or infrared image, process the image to identify the data marker, and extract the first identifier using image processing techniques. In some implementations, source device 235 can display the data marker on display 240.

Wearable device 205 can transmit at 315 the first identifier to network computing system 260. The first identifier allows network computing system 260 to locate source device 235 (for example, either via a lookup table or directly when the first identifier is the URL of the source medical device) on data network 255. At 320, network computing system 260 can transmit over data network 255 a request to source device 235 for the present settings. Source device 235 transmits the settings to network computing system 260 at 325. Network computing system 260 can receive the settings from source device 235 and, at 330, can confirm to source device 235 receipt of the settings. Source device 235 may clear its memory of the settings and/or be configured with different settings for a different patient.

Wearable device 205, having moved from being in proximity to source device 235 to being in proximity to destination device 245 (for example, in a different hospital room), can, at 335, receive an instruction to identify destination device 245 and push the settings to destination device 245. The instruction can originate with a user or wearer of wearable device 205 through a user interface, such as a voice command (via voice recognition module 230), or through a gesture, touch, or other input.

Wearable device 205 can scan camera's 210 field of view at 340 while destination device 245 and associated data marker is within the field of view. Camera 210 can capture a visual or infrared image, process the image to identify the data marker, and extract a second identifier using image processing techniques. The second identifier is associated with destination device 245 and is different from the first identifier, which is associated with source device 235. In some implementations, destination device 245 can display the data marker on display 250.

Wearable device 205 can transmit the second identifier to network computing system 260 and an instruction to push the settings to destination medical device at 345. The second identifier allows network-computing system 260 to locate destination device 245 on the data network 255 (for example, via either a lookup table or directly when the first identifier is the URL of the source medical device).

The network computing system 260 can push the settings to destination device 245 at 350. Destination device 245 can transmit a confirmation at 355 that the settings were received to network computing system 260. In some implementations, a confirmation can be displayed on display 250. Receipt of the settings can cause destination device 245 to update and configure using the received settings at 360.

Wearable device 205 can provide a visual confirmation that different steps have been completed, for example, when the first identifier is captured, when the settings have been transferred from source device 235, when the settings have been received by destination device 245, and when destination device 245 is configured for operation and/or updated with the settings.

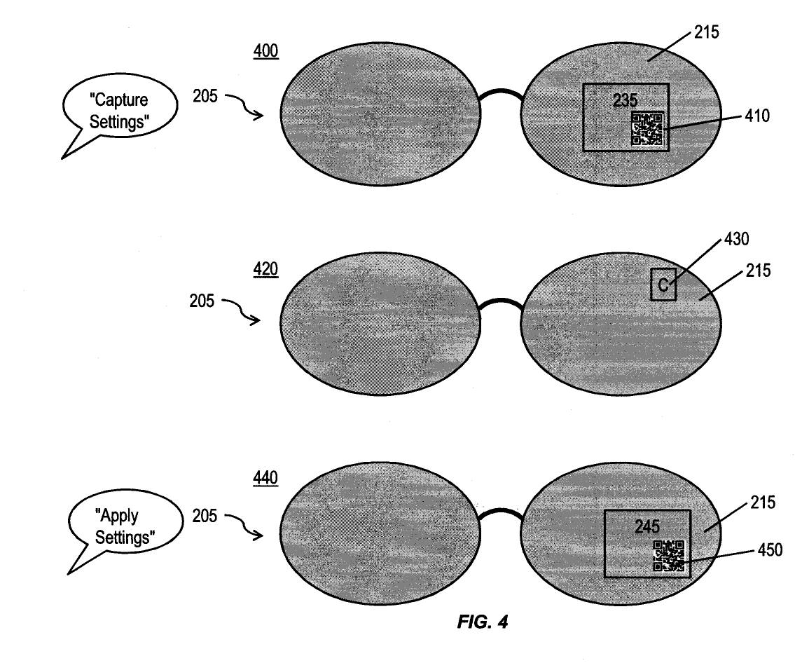

FIG. 4 illustrates wearable device 205 at different steps of an example data transfer process. At 400, the wearer points wearable device 205, including field of view display 215, towards source device 235. Since wearable device camera's 210 field of view overlaps with a wearer's field of view, source device 235 is within camera's 210 field of view. Source device 235 includes data marker 410, either displayed or attached to the device. In this case, data marker 410 is a two dimensional barcode. The wearer can issue a verbal instruction to wearable device 205 to capture the target device settings. Wearable device 205 can capture the identifier contained within data marker 410 as described above.

At 420, field of view display 215 can display an icon 430 indicating that the settings have been captured. The wearer can then “look at” destination device 245.

At 440, destination device 245 is within the field of view of camera 210. Destination device 245 can include a data marker 450 encoding the second identifier, in this case, in a two-dimensional barcode. The wearer can issue a verbal command to apply the captured settings. The captured settings can be applied to the destination device as described above.

Settings can include not only device settings such as device operating parameters, but physiological parameter data, such as historical heart rate, blood pressure, and other types of parameters, as well as patient characteristics, patient event data, alarm event history, device alarm configurations, physiological parameter trends, patient trend data, identity, laboratory results (e.g., blood work and the like) stored on the medical device, and other historical data.

Although a few variations have been described in detail above, other modifications are possible. For example, the wearable device 205 can scan the camera visual field automatically to identify the medical devices, and the wearer may confirm that data transfer should be performed. In some implementations, the wearable device 205 is regularly (e.g., periodically such as every 2 seconds) scanning the visual field for data markers of devices. When data markers are identified (e.g., via a QR code), the wearer can be informed that the medical device has settings which are available for transfer.

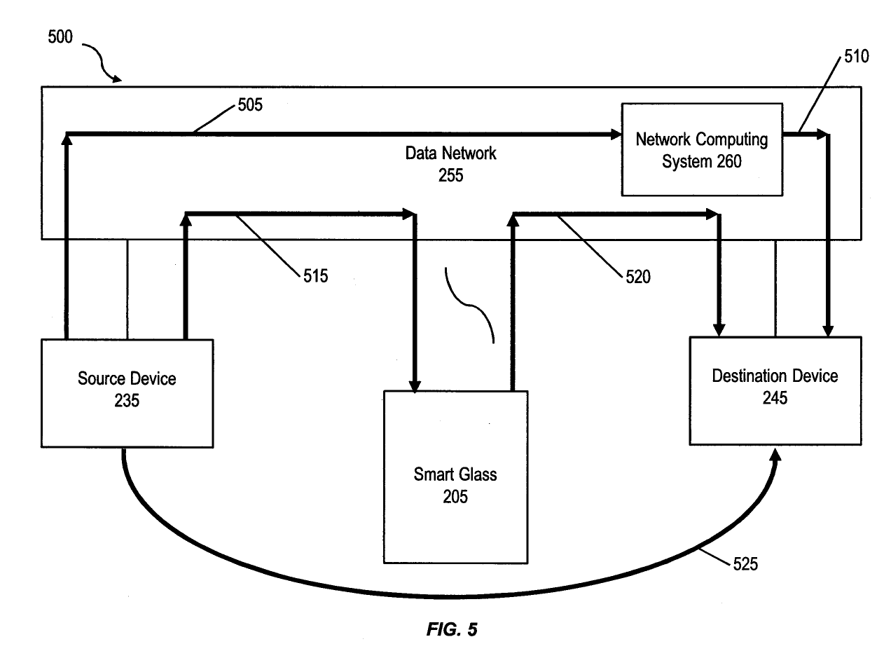

In another example variation, to provide for data transfer, the settings can, as described above, be temporarily stored on network computing system 260 during the transfer process; can be temporarily stored on wearable device 205; or source medical device 235 can directly transfer the settings to destination device 245. Some implementations may not include network computing system 260. FIG. 5 is a system block diagram 500 illustrating these three different data transfer techniques. Data flow lines 505 and 510 illustrate the settings being transferred over data network 255 to network computing system 260 for temporary storage, and then transferred to destination device 245 once an instruction from wearable device 205 including the second identifier is received.

Data flow lines 515 and 520 illustrate the settings being transferred over data network 255 to wearable device 205 for temporary storage and then transferred to destination device 245. In some implementations, the settings can be transferred directly to wearable device 205 via a wireless link between source device 235 and wearable device 205 and the settings can be transferred directly between wearable device 205 and destination device 245 via another wireless link between wearable device 205 and destination device 245. Data flow line 525 illustrates source device 235 transmitting the settings directly (e.g., over a Bluetooth, WIFI, or other link) to destination device 245. In this example, wearable device 205 can provide handshake information to the source and/or destination devices. For example, wearable device 205 can provide the second identifier from destination device 245 to source device 235 to push the settings to destination device 245. Wearable device 205 can provide the first identifier of source device 235 to destination device 245 for pulling the settings from source device 235.

Source device 235 and the destination device 245 can be different types of devices (e.g., heterogeneous device transfer). For example, the source device 235 can be a patient monitor while destination device 245 can be a fusion pump. Other types of devices are possible, for example, destination device 245 can be a slave display associated with source device 235.

Data transfer is not limited to a one-to-one device transfer. For example, a many-to-one device transfer can include aggregating settings and other data from multiple source devices 235 to a single destination device 245. These source devices 235 can be heterogeneous (e.g., different types, such as a patient monitor, fusion pump, ventilator, and the like). A many-to-many device transfer can include collecting settings from multiple devices and providing the settings to other devices, which may use all or just a subset of the collected settings. A one-to-many device transfer can include disseminating the settings from a single source device 235 to multiple destination devices 245, for example, settings may be transferred from a source patient monitor to a beside destination monitor and to a portable monitor that is carried by a healthcare worker to remotely observe the patient parameters.

In some implementations, network-computing device 260 can include a copy of the settings on source device 235 and can transfer the setting from network-computing device 260 to destination device 245 without querying source device 235.

While the above example describes using wearable device 205, the current subject matter can include other mobile computing devices or platforms, for example, a mobile phone, tablet, smart watch, or other type of computing device.

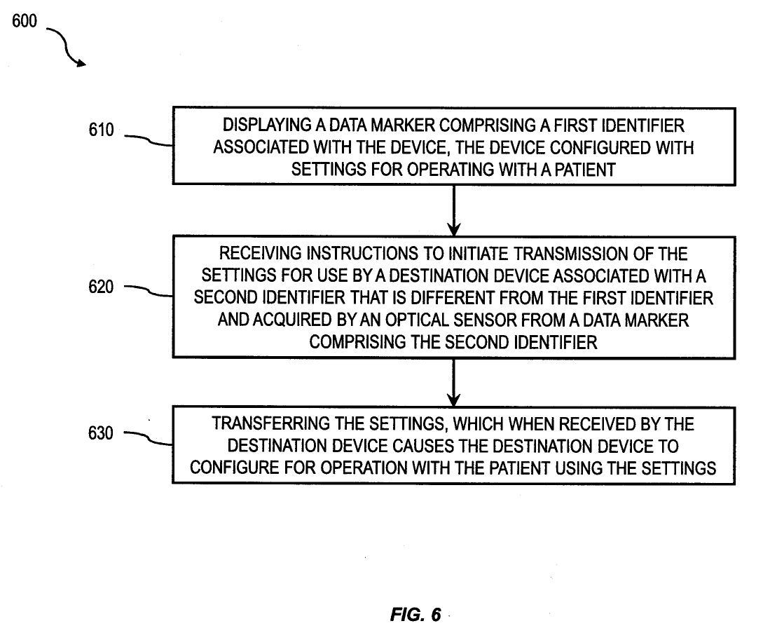

FIG. 6 is a process flow diagram illustrating an example method 600 for transferring settings to destination device 245. The example method 600 can be implemented by, for example, source device 235. A data marker can be displayed at 610. The data marker can include a first identifier associated with source device 235 that is configured with settings for operating with a patient.

Instructions can be received, at 620, to initiate transmission of settings for use by destination device 245 associated with a second identifier that is different from the first identifier. The second identifier can have been acquired by an optical sensor from a data marker that includes the second identifier.

The settings can be transferred at 630. When the settings are received by destination device 245, the settings and/or an instruction can cause destination device 245 to update and/or configure for operation with the patient using the settings. The settings can be transmitted over data network 255 to destination device 245. The settings can be transmitted to a mobile computing platform (e.g., wearable device 205) for temporary storage and subsequent transfer from the mobile computing platform to destination device 245. The settings can be transmitted directly from source device 235 to destination device 245.

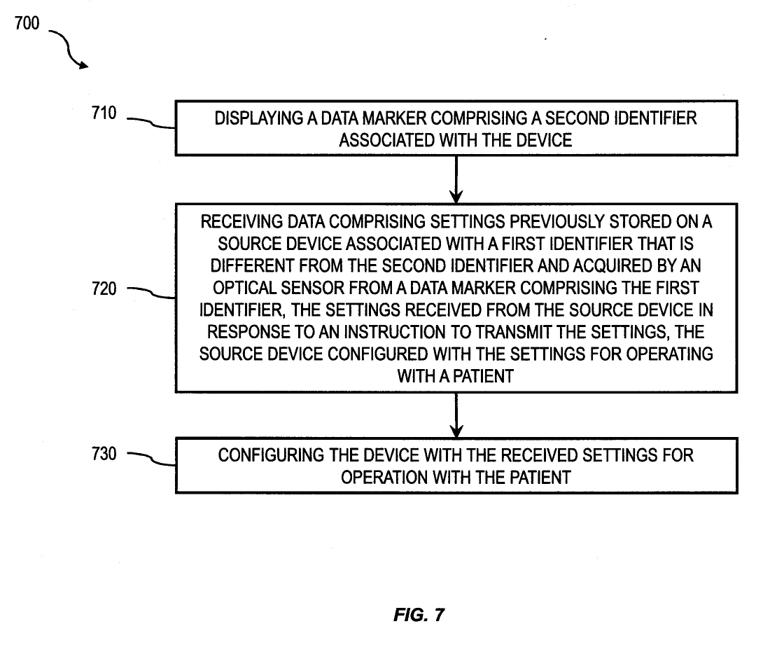

FIG. 7 is a process flow diagram illustrating a method 700 for transferring settings from a source device 235. The example method 700 may be implemented by, for example, destination device 245. A data marker can be displayed at 710 that includes a second identifier associated with destination device 245. The data marker can be displayed on a display of destination device 245.

Data including settings previously stored on the source device 235 can be received at 720. Source device 235 can be associated with the first identifier that is different from the identifier and having been acquired by an optical sensor from a data marker that includes the first identifier. The settings can be received from source device 235 in response to an instruction to transmit the settings and source device 235 can have been configured with the settings for operating with a patient.

Destination device 245 can be configured with the received settings for operating with the patient at 730. The settings can be received over data network 255 from source device 235 and having been temporarily stored on a network computing system 260 on data network 255. The settings can be received from a mobile computing platform including the optical sensor. The settings can be received after reception by the mobile computing platform of the settings from source device 235 and after temporary storage of the settings by the mobile computing platform. The settings can be received by destination device 245 directly from source device 235.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A method for implementation by an optical sensor in operation with at least one data processor forming part of at least one computing system, the method comprising:
receiving, by at least one data processor, data comprising an instruction to obtain settings from a source medical device;
scanning, by the optical sensor, a field of view of the optical sensor to acquire a first identifier associated with the source medical device;
transmitting, by at least one data processor, data comprising instructions to retrieve settings for the source medical device associated with the first identifier; and
initiating transfer of instructions to a destination medical device, which when received by the destination medical device, cause the destination medical device to update using the settings.

2. The method of claim 1, wherein the data comprising instructions to retrieve settings for the source medical device is transmitted to a network computing system.

3. The method of claim 1, further comprising:
receiving, by at least one data processor, data comprising an instruction to push the settings to the destination medical device;
scanning, by the optical sensor, the field of view of the optical sensor to acquire a second identifier associated with the destination medical device; and
transmitting, by at least one data processor and to the network computing system, data comprising an instruction to push settings to the destination medical device associated with the second identifier.

4. The method of claim 1, further comprising:
receiving, by at least one data processor and from the network computing system, the settings obtained from the source medical device; and
transmitting, by at least one data processor, the settings obtained from the source medical device for pushing the settings to the destination medical device.

5. The method of claim 1, wherein settings comprise one or more of: patient physiological parameter trend settings, alarm event history, patient characteristics, device alarm configuration settings, patient event data, patient trend data, device operating parameters, and laboratory results.

6. The method of claim 1, wherein the source medical device includes a data marker comprising the first identifier.

7. The method of claim 1, wherein the optical sensor and the at least one data processor form a wearable device and the field of view of the optical sensor overlaps with a wearer's field of view when the wearable device is worn.

8. The method of claim 1, wherein the source medical device comprises: a patient monitor, a ventilator, an infusion pump, anesthesia device, or incubator device.

9. The method of claim 1, wherein the first identifier is unique to the source medical device.

10. A method for implementation by an optical sensor in operation with at least one data processor forming part of at least one computing system, the method comprising:
receiving, by at least one data processor, data comprising an instruction to transfer settings from a source medical device;
scanning, by the optical sensor, a field of view of the optical sensor to acquire a first identifier associated with the source medical device;
scanning, by the optical sensor, the field of view of the optical sensor to acquire a second identifier associated with a destination medical device;
initiating, by at least one data processor, transfer of data comprising an instruction to transfer settings from the source medical device to the destination medical device, which when received by the destination medical device, cause the destination medical device to update using the settings.

11. The method of claim 10, wherein the first identifier is unique to the source medical device.

12. The method of claim 10, further comprising:
receiving, by at least one data processor and from the source medical device, the settings; and
transmitting, by at least one data processor, the settings obtained from the source medical device to the destination medical device.

13. The method of claim 10, wherein settings comprise one or more of: patient physiological parameter trend settings, alarm event history, patient characteristics, device alarm configuration settings, patient event data, patient trend data, device operating parameters, and laboratory results.

14. The method of claim 10, wherein the source medical device includes a first data marker comprising the first identifier and the destination medical device includes a second data marker comprising the second identifier.

15. The method of claim 10, wherein the optical sensor and the at least one data processor form a wearable computing device and the field of view of the optical sensor overlaps with a wearer's field of view when the wearable computing device is worn.

16. The method of claim 10, wherein the source medical device comprises a patient monitor, a ventilator, an infusion pump, anesthesia device, or incubator device.

17. A method for implementation by at least one data processor forming part of at least one computing system, the method comprising:
displaying, on a display of a medical device, a data marker comprising a first identifier associated with the medical device, the medical device configured with settings for operating with a patient;
receiving, using at least one data processor, instructions to initiate transmission of the settings for use by a destination medical device associated with a second identifier that is different from the first identifier and acquired by an optical sensor from a data marker comprising the second identifier; and
transferring, using at least one data processor, the settings, which when received by the destination medical device causes the destination medical device to configure for operation with the patient using the settings.

18. The method of claim 17, wherein the settings are transmitted over a network to the destination medical device.

19. The method of claim 17, wherein the settings are transmitted to a mobile computing platform comprising the optical sensor, the settings transmitted for temporary storage and subsequent transfer from the mobile computing platform to the destination medical device.

20. The method of claim 17, wherein the settings are transmitted directly from the medical device to the destination medical device.

21. A method for implementation by at least one data processor forming part of at least one computing system, the method comprising:
displaying, on a display of a medical device, a data marker comprising a second identifier associated with the medical device;
receiving, using at least one data processor, data comprising settings previously stored on a source medical device associated with a first identifier that is different from the second identifier and acquired by an optical sensor from a data marker comprising the first identifier, the settings received from the source medical device in response to an instruction to transmit the settings, the source medical device configured with the settings for operating with a patient; and
configuring, using at least one data processor, the medical device with the received settings for operation with the patient.

22. The method of claim 21, wherein the settings are received over a network from the source medical device.

23. The method of claim 21, wherein the settings are received from a mobile computing platform comprising the optical sensor, the settings received after reception by the mobile computing platform of the settings from the source medical device and after temporary storage of the settings by the mobile computing platform.

24. The method of claim 21, wherein the settings are received by the medical device directly from the source medical device.

25-26. (canceled)
